(19) United States
(12) Patent Application Publication
(10) Pub. No.: US 2011/0046751 A1
(43) Pub. Date: Feb. 24, 2011

(54) HOME NETWORK SYSTEM AND METHOD FOR CONTROLLING THE SAME

(75) Inventors: Keum-koo LEE, Seongnam-si (KR); Ji-young KWAHK, Seongnam-si (KR); Hee-jeong CHOO, Anyang-si (KR); Ju-yun SUNG, Yongin-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/860,464

(22) Filed: Aug. 20, 2010

(30) Foreign Application Priority Data
Aug. 21, 2009 (KR) 10-2009-0077503

(51) Int. Cl. G05B 15/02

(52) U.S. Cl. 700/19

(57) ABSTRACT

The home network system includes an input device to send a command set, and a control device to control in order entirely at least two devices to be controlled. With the home network system, devices can be controlled or regulated through transmission/reception between the devices so that the states or conditions of the devices can be remotely accomplished corresponding to the user's desire. Also, without inputting all a series of control instructions, by only one operation, the user can easily simply optimize the devices in the state or condition in that the user desires.

### CROSS-REFERENCE TO RELATED APPLICATIONS

This application claims the benefit under 35 U.S.C. §119(a) from Korean Patent Application No. 2009-077503 filed Aug. 21, 2009 in the Korean Intellectual Property Office, the disclosure of which is incorporated herein by reference in its entirety.

### BACKGROUND OF THE INVENTION

1. Field of the Invention

The present invention relates to a home network system and a method for controlling the same. More particularly, the present invention relates to a home network system that can entirely control devices to be controlled and a method for controlling the same.

2. Description of the Related Art

Generally, a home network system refers to a network system that performs network coordination between a home network disposed in a home and an external communication network to provide intelligent communication. The networking may allow information sources inside home to be shared and maximize the utility of each of devices.

Home devices that constitutes the home network may include information type devices such as personal computers, facsimiles, scanners, printers, etc., A/V type devices such as TVs, set top boxes, DVD players, VCRs, audios, camcorders, home game machines, etc., control type devices such as coffee makers, electric rice-cookers, refrigerators, washing machines, microwave ovens, cameras, etc., and dummy type devices such as remote controls, interphones, sensors, lights, etc.

In addition, nowadays, portable devices are included in the home network system so that the home network system can be used to control the portable devices as well as the home devices.

The home devices and portable devices are connected to a sub-network such as a telephone line, a wireless LAN, a Bluetooth, a Universal serial bus (USB), IEEE 1394, or a power line, etc. according to a category of each of the home devices and portable devices.

A conventional home network system can control the home devices and the portable devices, respectively. However, a user is required to manipulate each of the home devices and potable devices in order to cause each of the home devices and portable devices to satisfy a state or condition that the user desires.

### SUMMARY OF THE INVENTION

The present invention has been developed in order to overcome the above drawbacks and other problems associated with the conventional arrangement. An aspect of the present invention is to provide a home network system that can control all devices to be controlled at a time and a method for controlling the same.

The above aspect and/or other feature of the present invention can substantially be achieved by providing a home network system, which includes an input device to send a command set for controlling a plurality of device to be controlled; and a control device to control in order entirely at least two devices to be controlled among the plurality of device to be controlled based on the command set received from the input device.

Here, the command set may be a single control instruction causing a plurality of control instructions for controlling the at least two devices to be controlled to be generated in order in the control device.

The command set and the plurality of control instructions may be matched with each other and saved therein, and at least one of kind and order of the plurality of control instructions, and the device to be controlled can be changed by a user.

The control device may communicate with the plurality of device to be controlled so as to collect and save information with respect to the plurality of device to be controlled and information with respect to control instructions for controlling the plurality of device to be controlled.

The information with respect to the plurality of device to be controlled may include at least one of kinds, names, and manufacturers of the plurality of device to be controlled.

The control device may transmit in order the plurality of control instructions to the at least two devices to be controlled so as to entirely control the at least two device to be controlled.

The command set may be generated in the control devise. The input device may select one command set among at least one command set list that is generated and then transmitted by the control device, and send the selected command set to the control device.

The input device can be used as the device to be controlled, and one of the plurality of device to be controlled can be used as the input device.

One of the plurality of device to be controlled can be used as the control device.

The above aspect and/or other feature of the present invention can substantially be achieved by providing a method for controlling a home network system, which includes transmitting a command set for controlling in order entirely a plurality of device to be controlled; and transmitting in order control instructions with respect to the device to be controlled based on the command set.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view illustrating a home network system according to an embodiment of the present invention;

FIG. 2 is a view illustrating a home network system according to other embodiment of the present invention;

FIG. 3 is a view explaining a macro control method considering states of the other devices;

FIG. 4 is a view explaining a macro control method considering external environment;

FIGS. 5A to 5E are views explaining a method for associating a command set with control instructions;

FIG. 6 is a flowchart illustrating a method for controlling a home network system according to an embodiment of the present invention;

FIG. 7 is a block diagram illustrating a control device; and

FIG. 8 is a block diagram illustrating an input device and a device to be controlled.

Throughout the drawings, like reference numerals will be understood to refer to like parts, components and structures.

### DETAILED DESCRIPTION OF THE EXEMPLARY EMBODIMENTS

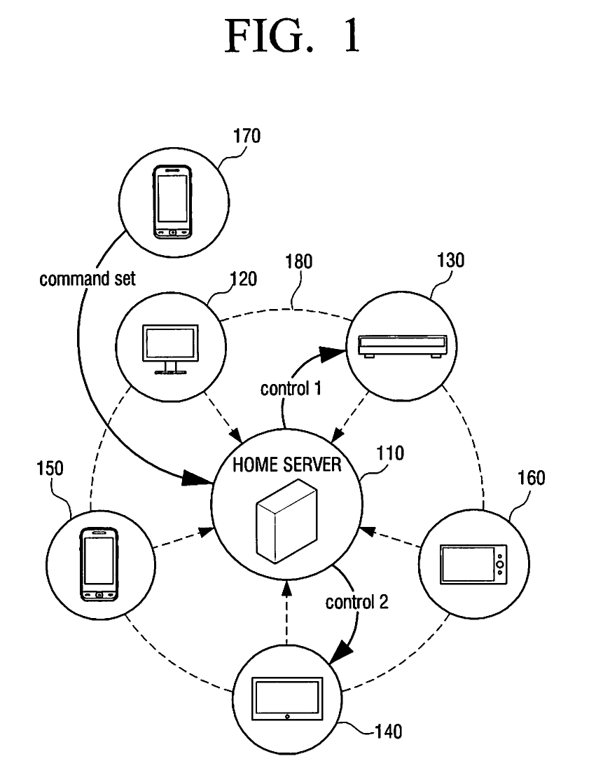

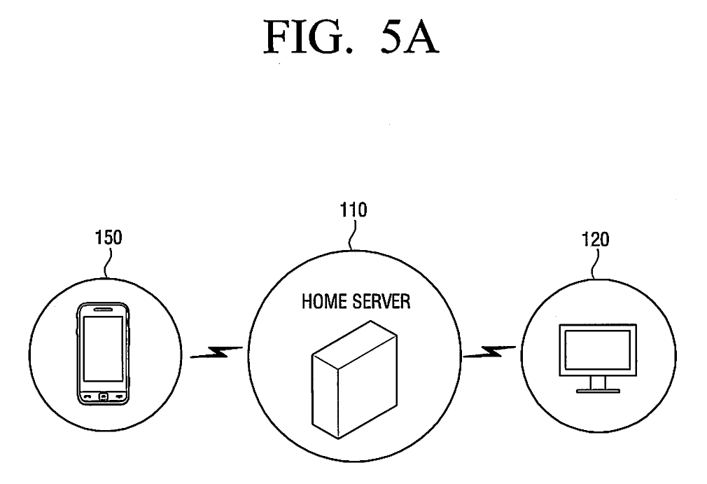

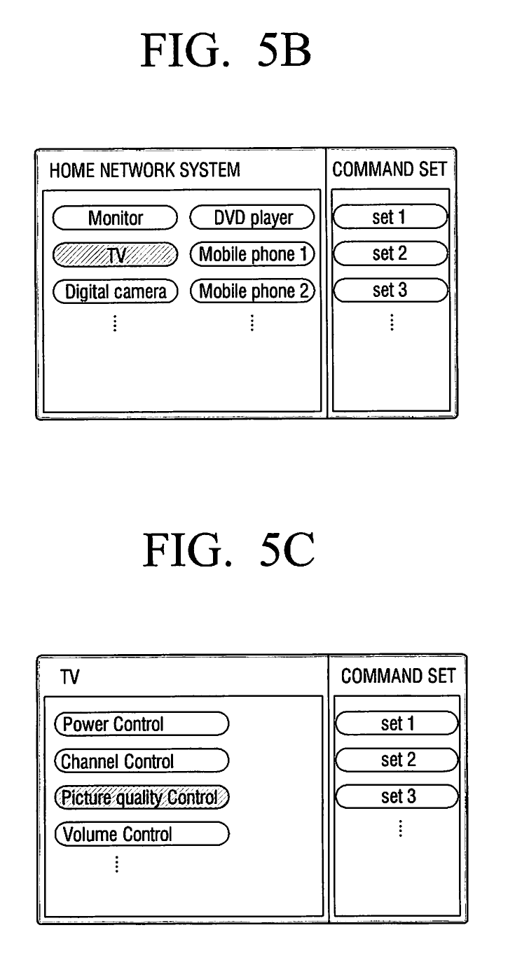

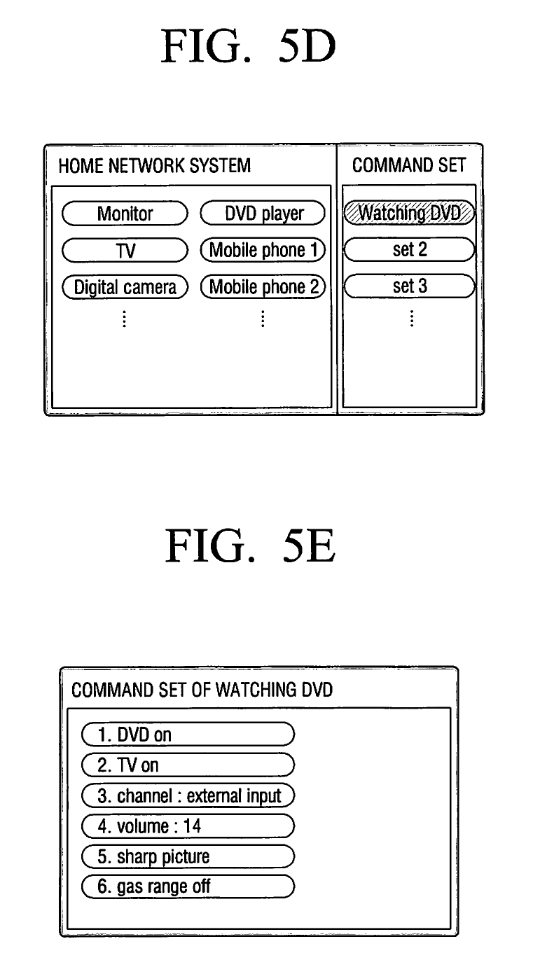

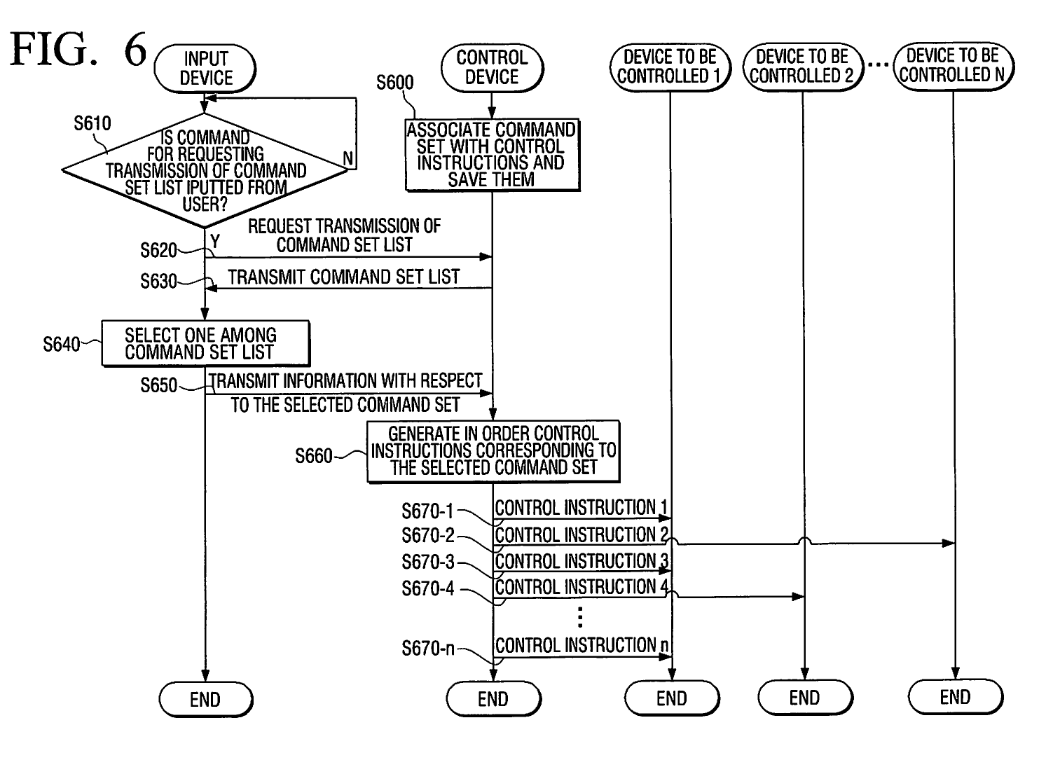

Hereinafter, certain exemplary embodiments of the present invention will be described in detail with reference to the accompanying drawings. FIGS. 1 to 4 are referred to explain a home network system for a macro control. FIGS. 5A to 5E are referred to explain a method for associating a command set with control instructions. FIGS. 6 to 8 are referred to explain a process and a constitution for generating control instructions based on a command set.

The matters defined in the description, such as a detailed construction and elements thereof, are provided to assist in a comprehensive understanding of the invention. Thus, it is apparent that the present invention may be carried out without those defined matters. Also, well-known functions or constructions are omitted to provide a clear and concise description of exemplary embodiments of the present invention.

<Macro Control Using a Server>

FIG. 1 is a view illustrating a home network system according to an embodiment of the present invention. The home network system according to an embodiment of the present invention control or regulate other devices through transmission/reception being performed between a center home server and devices.

The home network system may include a home server 110, home devices 120, 130, and 140, and portable devices 150, 160, and 170.

The home server 110 controls entire operations of devices included in the home network system. Particulary, the home server 110 generates a control instruction for controlling at least one device among the home devices 120, 130, and 140 and portable devices 150, 160, and 170 based on a command set remotely received from one among the home devices 120, 130, and 140 and portable devices 150, 160, and 170, and then sends the control instruction to each of the devices.

In addition, the home server 110 collects and saves information with respect to the devices inside the home network system for controlling at least one device based on the received command set. Concretely, the home server 110 may collect and save information of each of the devices, such as a kind, a name, and a manufacturer of the device, through wireless communication with the devices inside the home network system. Alternatively, the home server 110 may directly receive and save information with respect to the devices inside the home network system inputted by a user.

In order to generate a control instruction for controlling at least one device based on the received command set, the home server 110 saves information with respect to each of the command sets and information with respect to control instructions corresponding to each of the command sets.

In the one hand, the command set refers to an instruction (or command) that generates a group of control instructions including at least one control instruction that causes a specific state to be accomplished by at least one device or that causes a specific condition to be achieved by at least one device.

For example, when a command set for watching a DVD is remotely inputted into the home server 110 through a mobile phone 170 from outdoors, as illustrated in FIG. 1, the home server 110 sends a control instruction that causes a DVD player 130 to be turned on to the DVD player 130 according to the DVD watching command of the command set received from the mobile phone 170.

In addition, the home sever 110 sends a control instruction that causes a TV 140 to be turned on according to the DVD watching command of the command set received from the mobile phone 170 so that the TV 140 displays pictures being played by the DVD player 130.

On the one hand, the home devices 120, 130, and 140 refer to devices that are mostly used in a fixed location inside home. In this embodiment, for example, a monitor 120, the DVD player 130, and the TV 140 are illustrated as the home devices.

The portable devices 150, 160, and 170 refer to devices that a user mostly carries and uses outdoors. In this embodiment, for example, the mobile phone 150 and 170, and a digital camera 160 are illustrated as the portable devices.

In FIG. 1, a boundary 180 connecting each of devices is used to indicate that the devices are indoors. Therefore, it is found that there is the home server 110, the monitor 120, the DVD player 130, the TV 140, the mobile phone 150, and the digital camera 160 indoors and there is the mobile phone 170 outdoors.

As illustrated in FIG. 1, when the command set for watching the DVD is transmitted to the home server 110 through the mobile phone 170 outdoors, the home server 110 sends control instructions to control the DVD player 130 and the TV 140 based on the received command set for watching the DVD.

As described above, in this home network system, a state and a condition desired by the user are accomplished through transmission/reception performed between the outdoor devices and the center home server 110 and transmission/reception performed between the indoor devices and the center home server 110.

>Macro Control Using Devices>

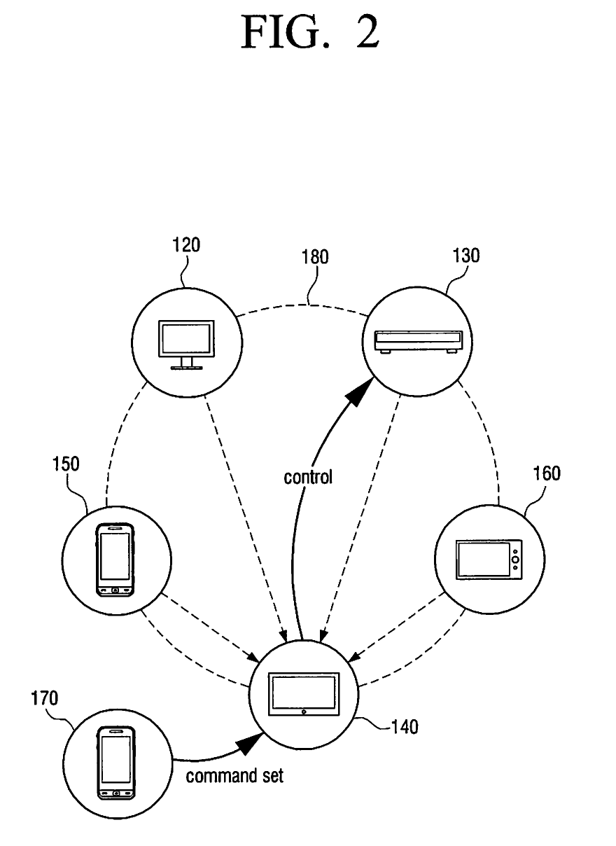

FIG. 2 is a view illustrating a home network system according to other embodiment of the present invention. The home network system according to this embodiment controls or regulates other devices through transmission/reception performed between devices.

The home network system may include the home devices 120, 130, and 140 and the potable devices 150, 160, and 170.

The home devices 120, 130, and 140 refer to devices that are mostly used in a fixed location inside home. In this embodiment, for example, the monitor 120, the DVD player 130, and the TV 140 are illustrated as the home devices.

The portable devices 150, 160, and 170 refer to devices that the user mostly carries and uses outdoors. In this embodiment, for example, the mobile phones 150 and 170, and the digital camera 160 are illustrated as the portable devices.

In FIG. 2, the boundary 180 connecting each of devices is used to indicate that the devices are located indoors. Therefore, it is found that there is the monitor 120, the DVD player 130, the TV 140, the mobile phone 150, and the digital camera 160 indoors and there is the mobile phone 170 outdoors.

On the one hand, one device among the devices locating indoors is used to control the entire home network system, that is, to perform a central control function. In this embodiment, the TV 140 is used to control the entire home network system.

The TV 140, which is used for the central control, controls entire operations of the devices inside the home network system. Particularly, the TV 140 generates a control instruction for controlling at least one device among the home devices 120 and 130 and portable devices 150, 160, and 170 based on a command set remotely received from one among the home devices 120, 130 and portable devices 150, 160, and 170, and then sends the control instruction to each of the devices.

In addition, the TV 140 collects and saves information with respect to the devices inside the home network system for controlling at least one device based on the received command set. Concretely, the TV 140 collects and saves information of each of the devices, such as a kind, a name, and a manufacturer of the device, through wireless communication with the other devices inside the home network system. Alternatively the TV 140 may directly receive and save the information with respect to the devices inside the home network system inputted by the user.

In order to generate a control instruction for controlling at least one device based on the received command set, the TV 140 saves information with respect to each of the command sets and information with respect to control instructions corresponding to each of the command sets.

In addition, when a command set for watching the DVD is remotely inputted into the TV 140 through the outdoor mobile phone 170 as illustrated in FIG. 2, the TV 140 sends a control instruction that causes the DVD player 130 to be turned on to the DVD player 130 according to the DVD watching command of the command set received from the mobile phone 170.

Then, the TV 140 turns on itself according to the DVD watching command of the command set received from the mobile phone 170 so that the TV 140 displays pictures being played by the DVD player 130.

As described above, in this home network system, a state and a condition that the user desires can be remotely accomplished by controlling or regulating the other devices through transmission/reception performed between the devices.

In the above description, the mobile phone 170 of the outdoor device is used to control entirely the indoor devices, however, this should not be considered as limiting. The technical spirit of the present invention may be useful in the home network system configured so that the indoor and/or outdoor devices are entirely controlled by using an indoor device. However, for controlling the outdoor device by using the indoor device, the home server 110 or the central control device should have a communication means for a remote control.

In the above description, the DVD player 130 and TV 140 are controlled to watch the DVD; however, watching the DVD is an exemplary state or condition for convenience of explanation. Therefore, the technical spirit of the present invention can be applied to states or conditions such as listening to music, game action, etc.

For example, when the user inputs a command set of listening to music into the home server 110 in order to set up the state or condition for listening to music by using the home network system, the home server 110 receives the command set from the user and then may sequentially entirely perform a power-on control, a volume control, and a music selection control of an MP3P (not shown) and a turn-off control of the DVD player 130.

This is identically applied to the following description.

<Macro Control Considering States of the Other Devices>

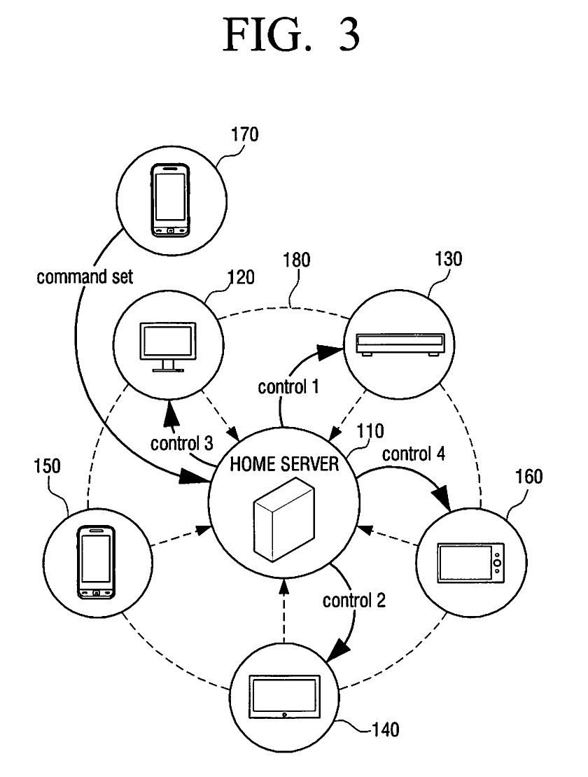

In the above description, the home network system is configured so that only devices required to watch the DVD are controlled; however, this is also an exemplary state for convenience of explanation. Therefore, the home network system may be configured so that devices that are not required to watch the DVD are controlled together with the devices that are required to watch the DVD. Hereafter, this case will be explained with reference to FIG. 3.

FIG. 3 is a view explaining a macro control method considering states of the other devices. The home network system illustrated in FIG. 3 has a home server for convenience of explanation and the following description is based on the home network system including the home server. However, the following description may be applied to a home network system without the home server.

When receiving a command set for watching the DVD from the mobile phone 170, the home server 110 generates a control instruction for controlling the indoor devices based on the received command set.

First, the home server 110, as described above, generates the control instructions for controlling the DVD player 130 and the TV 140, and then sends the control instructions to the DVD player 130 and the TV 140. Then the DVD player 130 and the TV 140 operate according to the received control instruction, respectively.

For example, if the control instruction transmitted to the DVD player 130 is a control instruction of ‘turn on and play after three minutes’, the DVD player 130 turns on and then plays after three minutes from when the control instruction is received according to the received control instruction. Also, if the control instruction transmitted to the TV 140 is ‘turn on, sharp picture, volume of 16, and subtitles on’, the TV 140 turns on itself and then adjusts setting values of the TV 140 to correspond to the ‘sharp picture, volume of 16, and subtitles on’ according to the received control instruction.

In addition, the home server 110 may check states of the other devices except for the DVD player 130 and the TV 140, generate a control instruction corresponding to the state of each of the other devices that are irrelevant to watch the DVD, and transmit the control instruction to each of the devices.

In other words, when the user watches the DVD, the user does not generally use the monitor 120 and the digital camera 160. Accordingly, the user may want to turn off the electric powers of the monitor 120 and the digital camera 160 when watching the DVD.

Therefore, the home server 110 may generate control instructions with respect to the monitor 120 and the digital camera 160 that are not required to watch the DVD as well as the DVD player 130 and the TV 140 required to watch the DVD, and then send each of the control instructions to each of the devices.

As a result, the home network system can provide a more optimized state or condition to the user.

<Macro Control Considering Environment>

As described above, the control instructions corresponding to the command set of the user inputted for satisfying the state or condition that the user desires are previously saved in the home server 110, and the home server 110 generates the control instructions corresponding to the command set of the user and sends the control instructions to each of the devices.

However, the home server 110 may be configured not to in any case generate uniformly the control instructions corresponding to the command set of the user but to generate different control instructions from each other according to the external environment. Hereafter, this case will be explained in detail.

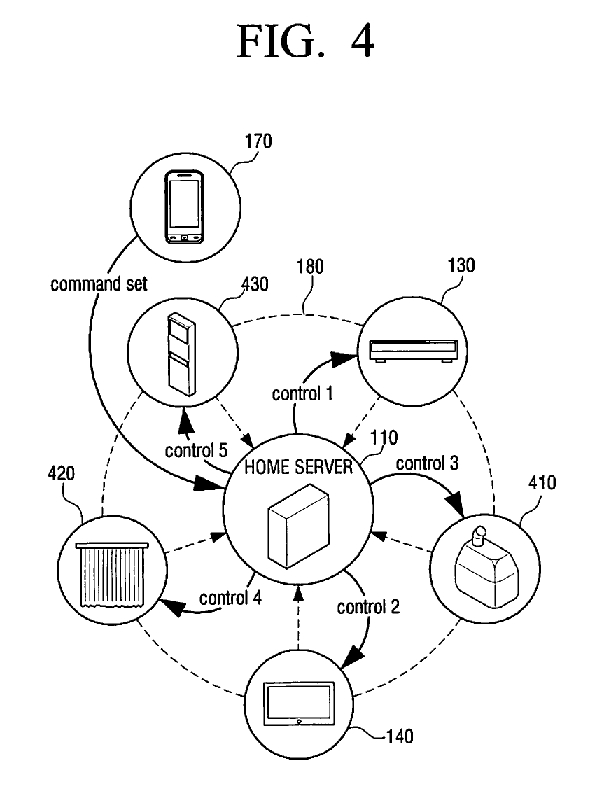

FIG. 4 is a view explaining a macro control method considering the external environment. The home network system illustrated in FIG. 4 has the home server for convenience of explanation and the following description is based on the home network system including the home server. However, the following description may be applied to a home network system without the home server.

On the one hand, the home network system 400 according to an embodiment of the present invention may include the home server 110 and the home devices 410, 420, 430. Also, the home devices may include a humidifier 410 for adjusting humidity, a curtain 420 for blocking sunlight, and an air conditioner 430 for controlling temperature.

As described above, when a user's command for watching the DVD, that is, a command set is inputted into the home server 110 through the outdoor mobile phone 170, the home server 110 controls operations of the DVD player 130 and the TV 140 based on the inputted command set.

Also, the home server 110 can generate arbitrary control instructions except for the control instructions corresponding to the command set of the user. That is, as illustrated in FIG. 4, when the command set for watching the DVD is inputted into the home server 110 from the user, the home server 110 can also generate control instructions with respect to the humidifier 410, the curtain 420, and the air conditioner 430 that have no direct relationship with watching the DVD.

The control instructions with respect to the humidifier 410 and the air conditioner 430 can be generated based on the present temperature and humidity, and a kind of the device from which the user command for watching the DVD is inputted, that is, the indoor device or the outdoor device.

For example, if the user command for watching the DVD is inputted from the indoor device, the user is considered to be indoors. Therefore, it is conceivable that the user is satisfied with the present indoor temperature and humidity. Accordingly, if the user command for watching the DVD is inputted from the indoor device, the home server 110 does not generate separate control instructions with respect to the humidifier 410 and the air conditioner 430 regardless whether the humidifier 410 and the air conditioner 430 are turned on or off.

However, if the user command for watching the DVD is inputted from the outdoor device, the user is considered to be outdoors. As a result, it cannot be determined whether or not the user is satisfied with the present indoor temperature and humidity. Therefore, if the user command for watching the DVD is inputted from the outdoor device, it could be thought that the user will soon watch the DVD indoors. Accordingly, the home server 110 generates separate control instructions with respect to the humidifier 410 and the air conditioner 430 for controlling the humidifier 410 and the air conditioner 430 in the optimum temperature and humidity for watching the DVD.

On the one hand, the control instruction with respect to the curtain 420 may be generated based on the present time and the weather such as an amount of sunlight entering indoors, etc.

For example, if the time when the command for watching the DVD is inputted from the user is the morning or the time when a large amount of sunlight enters indoors, the user may feel inconvenience in watching the DVD due to the darling light of the sun. Therefore, the home server 110 sends a control instruction for drawing the curtain 420 to the curtain 420 so that the user can conveniently watch the DVD.

Also, if the time when the command for watching the DVD is inputted from the user is the evening or the time when a small amount of sunlight enters indoors, the user may feel little inconvenience in watching the DVD due to the dazzling light of the sun. Therefore, the home server 110 does not send a separate control instruction to the curtain 420 so that the curtain 420 remains the present state thereof.

As a result, the home network system can provide a more optimized state or condition to the user.

<Method for Associating a Command Set with Control Instructions>

In the above description, the home server saves the command set and control instructions corresponding to the command set. Hereinafter, a process in that the home server associates the command set with the control instructions and saves them will be explained with reference to FIGS. 5A to 5E. The home network system is explained based on the home network system illustrated in FIG. 1.

FIGS. 5A to 5E are views explaining a method for associating a command set with control instructions.

As described above, the home server 110 automatically collects and saves information with respect to home devices or potable devices inside the home network system. Also, the home server saves information with respect to the devices inside the home network system directly inputted by the user.

The home server 110 may have an input member and a display member therein for the user to directly input the information with respect to the devices inside the home network system or to change the information that the home server automatically collected and saved. Alternatively, as illustrated in FIG. 5A, the mobile phone 150 may be used as the input member of the home server 110 and the monitor 120 may be used as the display member of the home server 110.

When the mobile phone 150 is used as the input member as illustrated in FIG. 5A, the home server 110 allows the information with respect to the devices inside the home network system to be entered or allows the automatically collected information with respect to the devices inside the home network system to be changed and saved based on a signal inputted from the mobile phone 150.

Also, when the monitor 120 is used as the display member, the home server 110 displays the entered information with respect to the devices inside the home network system or the information with respect to the devices inside the home network system that is automatically collected, changed and saved on the monitor 120. Therefore, the user can check the information while watching a picture displayed on the monitor 120.

As described above, the home server 110 can receive the information and change the inputted information by using the input member and the display member.

Further, the home server 110 can associate the command set with the control instructions by using the input member and the display member. FIG. 5B illustrates a picture being displayed on the display member for matching the command set with the control instructions in the home network system. As illustrated in FIG. 5B, the devices constituting the home network system are represented on the left side of the picture as items (or icons) and the command sets are represented on the right side of the picture as items.

When the user selects a TV item via the input member, the display member displays control instruction items for controlling the TV 140 on a screen thereof as illustrated in FIG. 5C. Then when the user selects an item of picture quality control among the control instruction items, the display member displays specific items for controlling the picture quality of the TV 140 on the screen thereof.

The user can repeat the process described above with respect to each of the devices inside the home network system, and select specific control instructions with respect to the devices inside the home network system. Thus the user matches the selected item with one of the command sets on the right side of the picture, thereby completing one command set.

On the one hand, as illustrated in FIG. 5D, the user can change a name of the completed command set through the input member to easily distinguish the command sets.

After the command set is completed and the name of the command set is determined, the user can check command instructions corresponding to the command set as illustrated in FIG. 5E. As illustrated in FIG. 5E, the command set for ‘watching the DVD’ is ‘1. DVD on→2. TV on→3. channel: external input→4. volume: 14→5. sharp picture quality→6. gas range off.’

The user can check the command set for ‘watching the DVD’ and change the order of the command instructions corresponding to the command set for ‘watching the DVD’ through the display member. That is, the user can change the order of the items that is ‘1. DVD on’, ‘2. TV on’, ‘3. channel: external input’, ‘4. volume: 14’, ‘5. sharp picture quality’, and ‘6. gas range off’ so as to determine an order in which the home server 110 sends the control instructions to the devices after the command set is inputted into the home server 110.

On the one hand, the command sets generated as described above are transmitted to each of the devices inside the home network system. Concretely, when receiving a request of transmitting a command set from a specific device that is manipulated by the user, the home server 110 sends the command set to the specific device manipulated by the user. As a result, the user can control the entire home network system through the specific device.

With an embodiment of the present invention, because the user can control the home network system by one operation without inputting all a series of control instructions, the user can easily optimize the devices inside the home network system to correspond to the state or condition that the user desires.

On the one hand, the process for associating the command set with the control instructions is only by way of example for convenience of explanation. The technical spirit of the present invention is useful in associating the command set with the control instructions by using other processes or other methods.

<Process and Configuration for Generating Control Instructions Based on a Command Set>

Hereinafter, a process in that the command set and the control instructions are associated with each other and saved and a process in that the control instructions are transmitted to each of the devices based on the command set inputted by the user will be explained.

FIG. 6 is a flowchart illustrating a method for controlling a home network system according to an embodiment of the present invention.

As described above, a control device associates the command set with the control instructions, and then saves them (S600). Here, the control device is the home server or any device performing a central control of the home network system instead of the home server that associates the command set with the control instructions and saves them.

An input device determines whether a command for requesting transmission of a command set list saved in the control device is inputted into the input device from the user (S610). Here, the input device is a device that is manipulated by the user and controls the entire devices inside the home network system to satisfy the state or condition that the user desires.

Upon determining that the command for requesting transmission of the command set list is inputted from the user (S610-Y), the input device sends a signal for requesting transmission of the command set list to the control device (S620), and the control device sends the command set list to the input device according to the transmission request of the command set list (S630).

When the user selects one command set among the command set list by using the input device (S640), the input device transmits information with respect to the selected command set to the control device (S650).

The control device generates in order control instructions corresponding to the selected command set by using the information receiving from the input device (S660).

Also, the control device selects devices to be controlled (a device to be controlled 1˜a device to be controlled N) to which each of the generated control instructions is sent, and then sends each of the generated control instructions to each of the devices to be controlled (S670-1˜S670-n). Here, the devices to be controlled refer to devices inside the home network system.

As described above, the user can easily simply control the devices inside the home network system by using the input device.

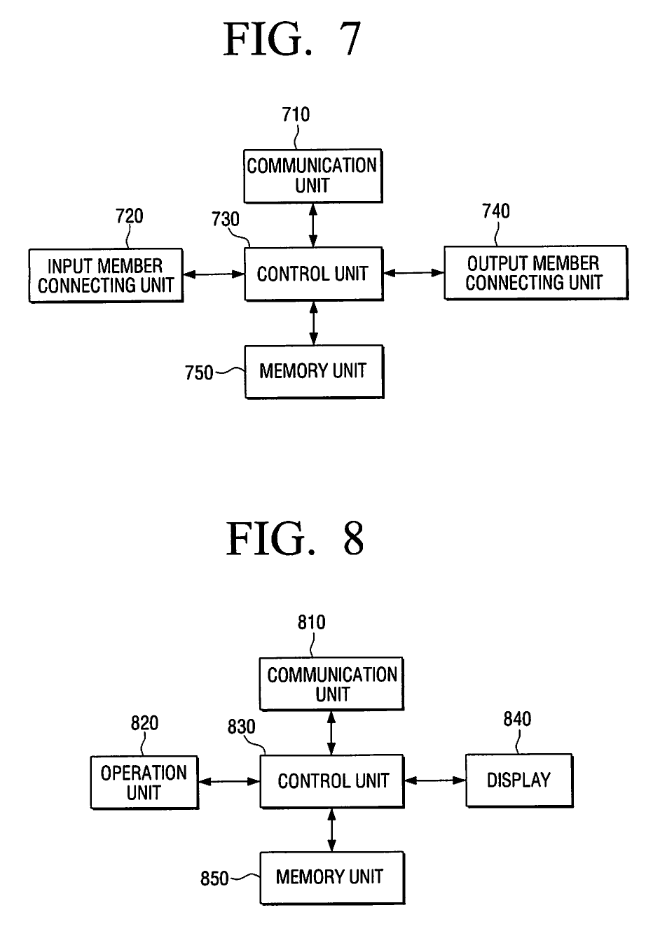

FIG. 7 is a block diagram illustrating the control device described above. Only elements that are needed to explain the present invention are illustrated in FIG. 7.

The control device may include a communication unit 710, an input member connecting unit 720, a control unit 730, an output member connecting unit 740, and a memory unit 750.

The communication unit 710 is used to communicate with the input device or the device to be controlled, to receive a command set, and to send control instructions.

The input member connecting unit 720 is an interface with which the input member is connected. The input member receives the user's operation for generating the command set in the control device.

The output member connecting unit 740 is an interface with which the display member is connected. The display member displays contents of the user's operation for generating the command set in the control device and contents of the generated command set.

The memory unit 750 is used to save the command set generated by the user and the control instructions corresponding to the command set therein.

The control unit 730 controls the entire control device, generates control instructions based on information with respect to the command set receiving from the input device, and sends in order the generated control instructions to each of the devices to be controlled.

On the one hand, FIG. 8 is a block diagram illustrating the input device and the device to be controlled as described above. The input device can be used as a device to be controlled, and the device to be controlled can be used as an input device. Therefore, the input device will be referred to the device to be controlled and explained with the same drawing hereinafter. Only elements that are needed to explain the present invention are illustrated in FIG. 8.

The device to be controlled may include a communication unit 810, an operation unit 820, a control unit 830, a display 840, and a memory unit 850.

The communication unit 810 is used to communicate with the control device, to transmit a command set, and to receive control instructions.

The operation unit 820 is used to cause the command set to be generated in the control device or to select one among the command set list.

The display 840 is used as a display member for displaying the command set list, etc.

The memory unit 850 is used to save the command set list generated by the user's operation and setting values according to the received control instructions therein.

The control unit 830 controls the entire device to be controlled, communicates with the control device to receive the command set list, transmits information with respect to a command set selected among the received command set list to the control device, and causes the device to be controlled to operate according to the control instructions received from the control device.

With the home network system according to an embodiment of the present invention, devices can be controlled or regulated through transmission/reception being performed between the devices so that the states or conditions of the devices can be remotely accomplished corresponding to the user's desire. Also, without inputting all a series of control instructions, by only one operation, the user can easily simply optimize the devices inside the home network system in the state or condition in that the user desires.

While the embodiments of the present invention have been described, additional variations and modifications of the embodiments may occur to those skilled in the art once they learn of the basic inventive concepts. Therefore, it is intended that the appended claims shall be construed to include both the above embodiments and all such variations and modifications that fall within the spirit and scope of the invention.

What is claimed is:

1. A home network system comprising:
an input device to send a command set for controlling a plurality of devices to be controlled; and
a control device to control in order entirely at least two devices to be controlled among the plurality of devices to be controlled based on the command set received from the input device.

2. The home network system of claim 1,
wherein the command set is a single control instruction causing a plurality of control instructions for controlling the at least two devices to be controlled to be generated in order in the control device.

3. The home network system of claim 2,
wherein the command set and the plurality of control instructions are matched with each other and saved in the control device, and at least one of kind and order of the plurality of control instructions, and the device to be controlled can be changed by a user.

4. The home network system of claim 2,
wherein the control device communicates with the plurality of device to be controlled so as to collect and save information with respect to the plurality of devices to be controlled and information with respect to control instructions for controlling the plurality of devices to be controlled.

5. The home network system of claim 4,
wherein the information with respect to the plurality of devices to be controlled comprises at least one of kinds, names, and manufacturers of the plurality of device to be controlled.

6. The home network system of claim 2,
wherein the control device transmits in order the plurality of control instructions to the at least two devices to be controlled so as to entirely control the at least two devices to be controlled.

7. The home network system of claim 1,
wherein the command set is generated in the control devise, and
wherein the input device selects one command set among at least one command set list that is generated and then transmitted by the control device, and sends the selected command set to the control device.

8. The home network system of claim 1,
wherein the input device can be used as the device to be controlled, and one of the plurality of devices to be controlled can be used as the input device.

9. The home network system of claim 1,
wherein one of the plurality of devices to be controlled is used as the control device.

10. A method for controlling a home network system, comprising:
transmitting a command set for controlling in order entirely a plurality of devices to be controlled; and
transmitting in order control instructions with respect to the devices to be controlled based on the command set.
